(19) United States
(12) Patent Application Publication
(10) Pub. No.: US 2025/0077610 A1
(43) Pub. Date: Mar. 6, 2025

(54) REDUCING WEBSITE OVERHEAD USING REGISTRIES

(71) Applicant: Capital One Services, LLC, McLean, VA (US)

(72) Inventors: Erol UNAL, Allen, TX (US); Grace TSUI, Chicago, IL (US)

(21) Appl. No.: 18/457,730

(22) Filed: Aug. 29, 2023

(51) Int. Cl. G06F 16/958; G06F 16/957

(52) U.S. Cl. CPC G06F 16/958; G06F 16/9577

(57) ABSTRACT

In some implementations, a user device may receive, from a website host, a webpage encoding a scaffold with a set of slots. The user device may transmit, to a registry host, a request for website elements from a set of possible website elements. The user device may receive, from the registry host and in response to the request for website elements, code for a subset of website elements from the set of possible website elements. The user device may output the subset of website elements in the set of slots.

### BACKGROUND

Webpages often include multiple elements (e.g., text, images, and/or interactive elements, among other examples). Usually, a user device (e.g., a laptop, a smartphone, or a desktop computer, among other examples) receives, over a network, one or more files encoding all the elements of a webpage.

### SUMMARY

Some implementations described herein relate to a system for using registries to selectively load website elements. The system may include one or more memories and one or more processors communicatively coupled to the one or more memories. The one or more processors may be configured to receive a webpage encoding a scaffold with a plurality of slots. The one or more processors may be configured to transmit a request for feature flags. The one or more processors may be configured to receive, in response to the request for feature flags, a set of feature flags. The one or more processors may be configured to transmit a request for website elements, from a registry, based on the set of feature flags. The one or more processors may be configured to receive, in response to the request for website elements, code for a plurality of website elements corresponding to the plurality of slots. The one or more processors may be configured to output the plurality of website elements in the plurality of slots.

Some implementations described herein relate to a method of using registries to selectively load website elements. The method may include receiving, from a website host, a webpage encoding a scaffold with a set of slots. The method may include transmitting, to a registry host, a request for website elements from a set of possible website elements. The method may include receiving, from the registry host and in response to the request for website elements, code for a subset of website elements from the set of possible website elements. The method may include outputting, by a user device, the subset of website elements in the set of slots.

Some implementations described herein relate to a non-transitory computer-readable medium that stores a set of instructions for using registries to selectively load website elements. The set of instructions, when executed by one or more processors of a device, may cause the device to receive a request for website elements from a set of possible website elements. The set of instructions, when executed by one or more processors of the device, may cause the device to retrieve, from at least one registry file, code for a subset of website elements from the set of possible website elements. The set of instructions, when executed by one or more processors of the device, may cause the device to transmit, in response to the request for website elements, the code for the subset of website elements.

### BRIEF DESCRIPTION OF THE DRAWINGS

FIGS. 1A-1D are diagrams of an example implementation relating to reducing website overhead using registries, in accordance with some embodiments of the present disclosure.

FIG. 2 is a diagram of an example user interface (UI) with placeholders, in accordance with some embodiments of the present disclosure.

FIG. 3 is a diagram of an example UI with elements from a registry file, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to reducing website overhead using registries, in accordance with some embodiments of the present disclosure.

### DETAILED DESCRIPTION

The following detailed description of example implementations refers to the accompanying drawings. The same reference numbers in different drawings may identify the same or similar elements.

A webpage may include multiple elements (e.g., text, images, and/or interactive elements, among other examples). Usually, a user device (e.g., a laptop, a smartphone, or a desktop computer, among other examples) receives, over a network, one or more files encoding all the elements of the webpage. In order to improve render times for a webpage, some elements may be deferred, which is referred to as “lazy loading.” For example, an image or frame that is further down on a webpage may be deferred until a user, of the user device, scrolls down closer to the image or frame. In another example, JavaScript® elements may be delayed until activated (e.g., via an interaction from the user).

However, when a webpage is coded to render a selection of elements, out of a larger set of possible elements, the user device generally receives some code for the whole set of possible elements, even code that is not rendered. As a result, the user device wastes network overhead, processing resources, and memory and increases latency for the user (degrading the user's experience). Additionally, the user device may use a computationally-heavy switch statement (e.g., in JavaScript) to determine the selection of elements to render.

Some implementations described herein enable a user device to request website elements for a webpage, out of a set of possible website elements, from a registry host. As a result, the user device receives and processes only a portion of code included in a registry file at the registry host, which conserves network overhead, processing resources, and memory as compared with receiving and processing code for the whole set of possible website elements. Additionally, the webpage loads faster, which improves a user's experience. Some implementations additionally enable the user device to use feature flags to determine the website elements, out of the set of possible website elements, to request. As a result, the user device conserves processing resources as compared with using a computationally-heavy switch statement.

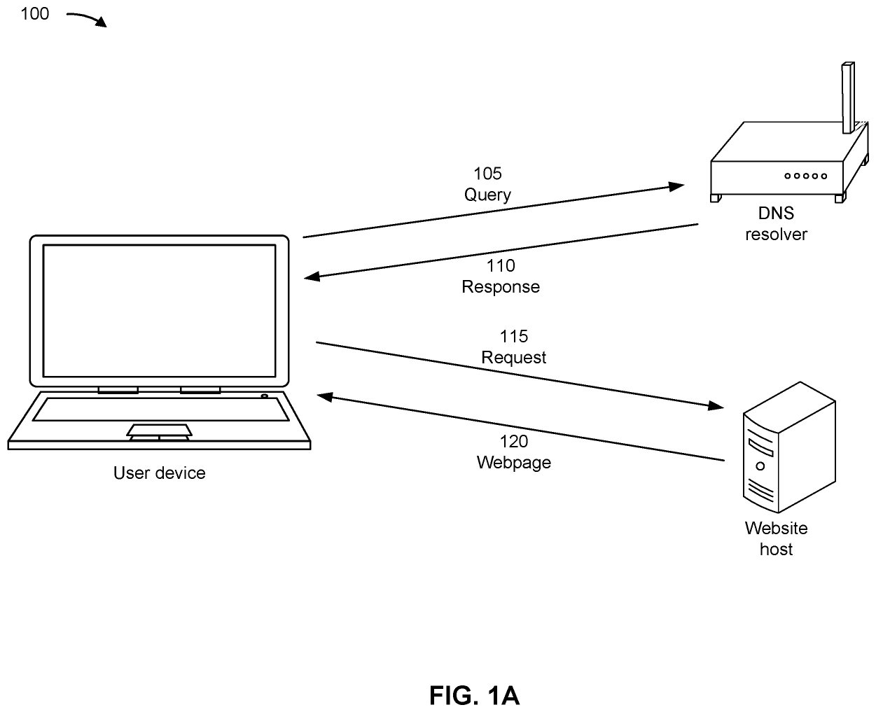

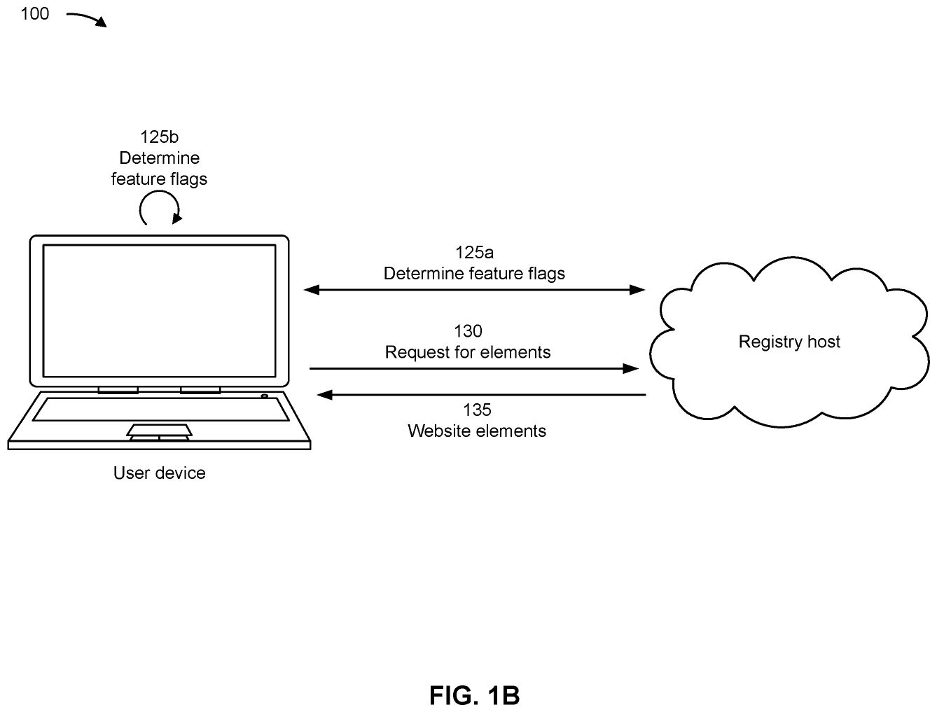

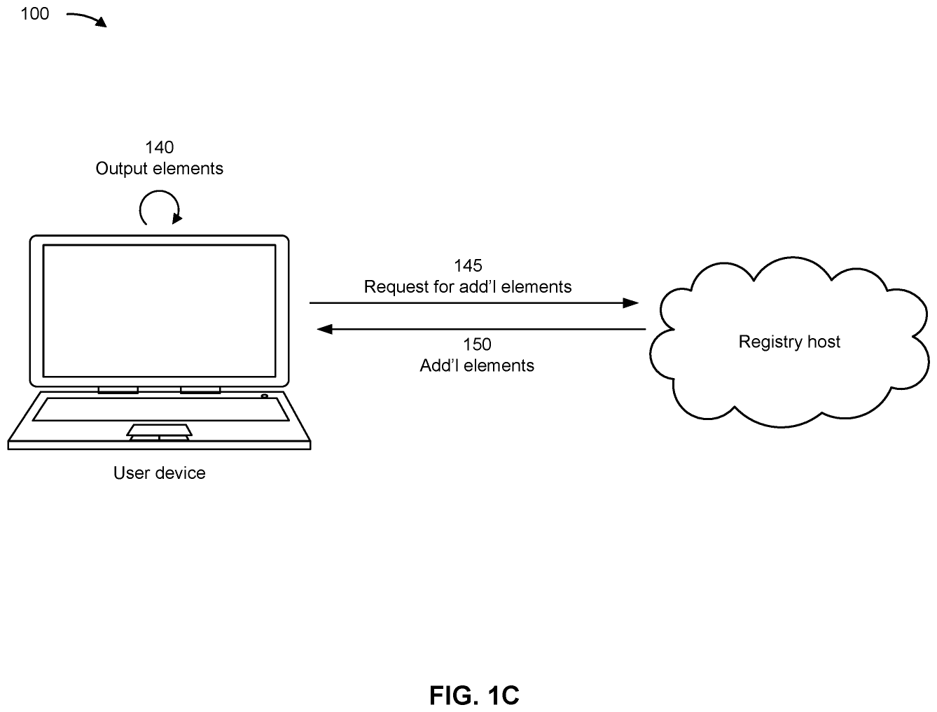

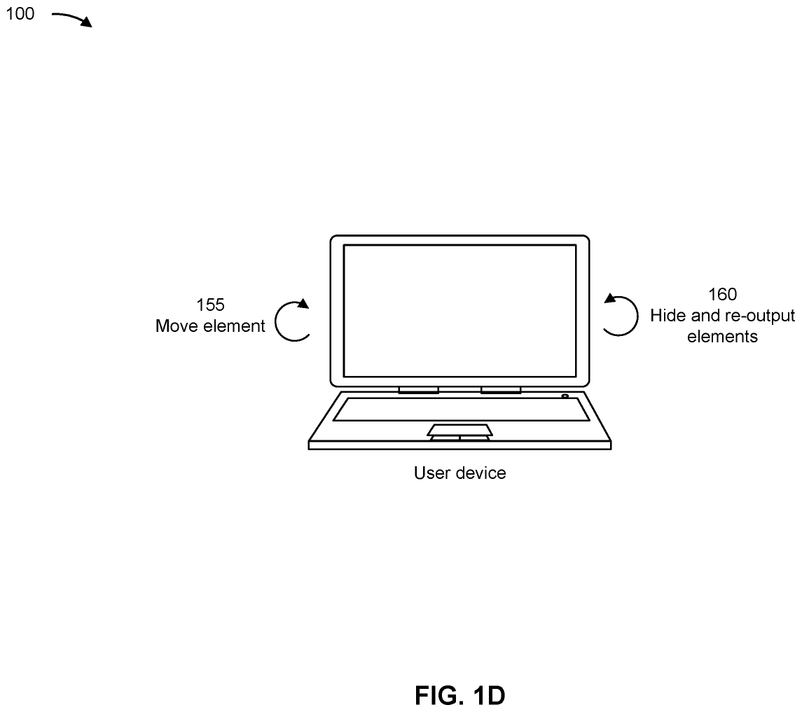

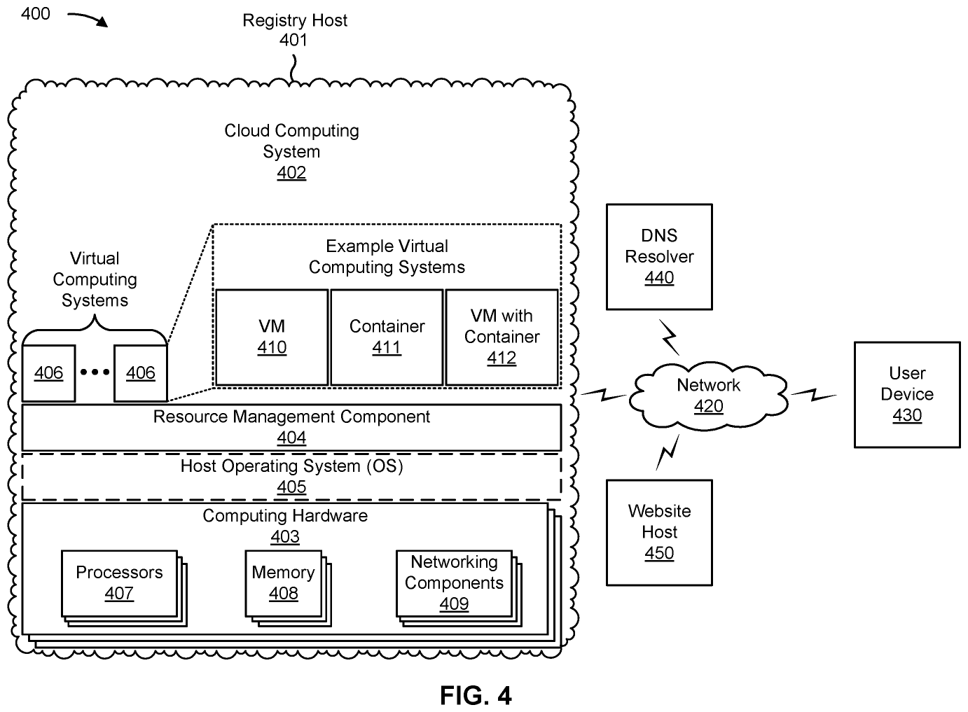

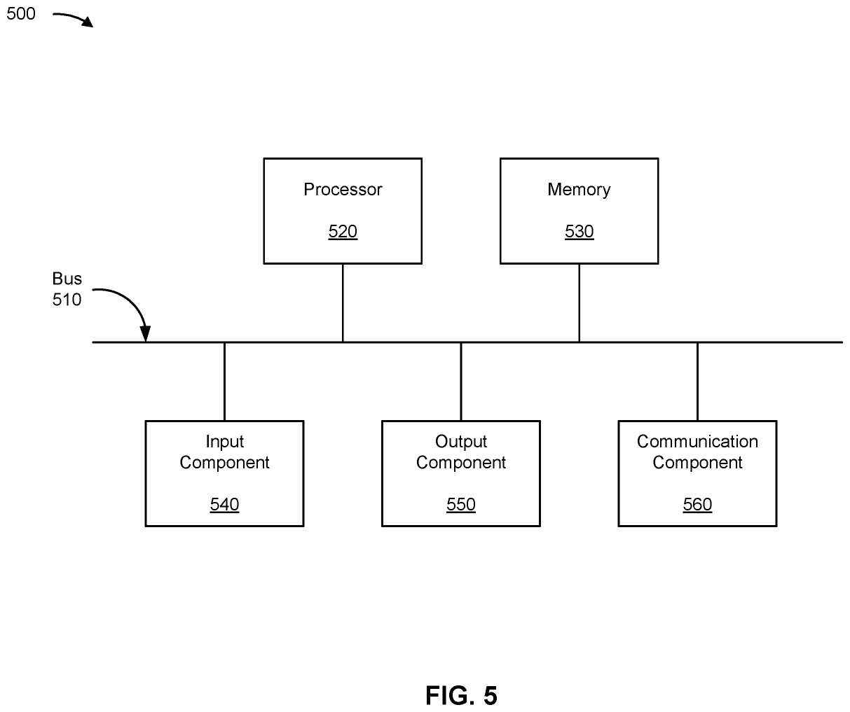

FIGS. 1A-1D are diagrams of an example 100 associated with reducing website overhead using registries. As shown in FIGS. 1A-1D, example 100 includes a user device, a domain name system (DNS) resolver, a website host, and a registry host. These devices are described in more detail in connection with FIGS. 4 and 5.

As shown in FIG. 1A and by reference number 105, the user device may transmit, and the DNS system may receive, a query. The query may include a domain name or another type of human-readable name for which the user device is requesting an Internet protocol (IP) address or another type of machine-readable address. The query may be included in a hypertext transfer protocol (HTTP) request and/or may be included as an argument of a call to an application programming interface (API) function.

In some implementations, a user of the user device may interact with a web browser (or another similar type of application) executed by the user device in order to trigger the user device to transmit the request. For example, the web browser may output (e.g., via an output component of the user device) a user interface (UI), such as a browser tab including a navigation bar. Accordingly, the user may input (e.g., via a keyboard, a microphone, and/or another input component of the user device) the domain name into the navigation bar and input a signal (e.g., by hitting an “Enter” key, clicking or tapping a confirmation button, or speaking a command, among other examples) that triggers the user device to transmit the query.

As shown by reference number 110, the DNS resolver may transmit, and the user device may receive, a response to the query. The response may include the IP address (or another type of machine-readable address) associated with the domain name. The response may include an HTTP response and/or may be returned based on a call to an API function (hosted by, or at least associated with, the DNS resolver).

Although the example 100 includes the user device receiving the machine-readable address from the DNS resolver, other examples may include the user device receiving the machine-readable address from a local memory (e.g., a cache controlled by the user device). For example, the user device may have previously resolved the domain name and cached the IP address associated with the domain name. Accordingly, the user device may use the cached IP address when the user inputs the same domain name.

As shown by reference number 115, the user device may transmit, and the website host may receive, a request for a webpage (e.g., associated with the domain name). The request may include an HTTP request and/or a file transfer protocol (FTP) request, among other examples. The user device may transmit the request based on the response to the query. For example, the user device may transmit the request to an endpoint (e.g., an IP address) indicated in the response to the query.

As shown by reference number 120, the website host may transmit, and the user device may receive, the webpage (in response to the request for the webpage). The webpage may include a hypertext markup language (HTML) file (e.g., at least one HTML file). Additionally, in some implementations, the webpage may include a cascading style sheets (CSS) file (e.g., at least one CSS file) and/or a JavaScript file (e.g., at least one JavaScript file), among other examples.

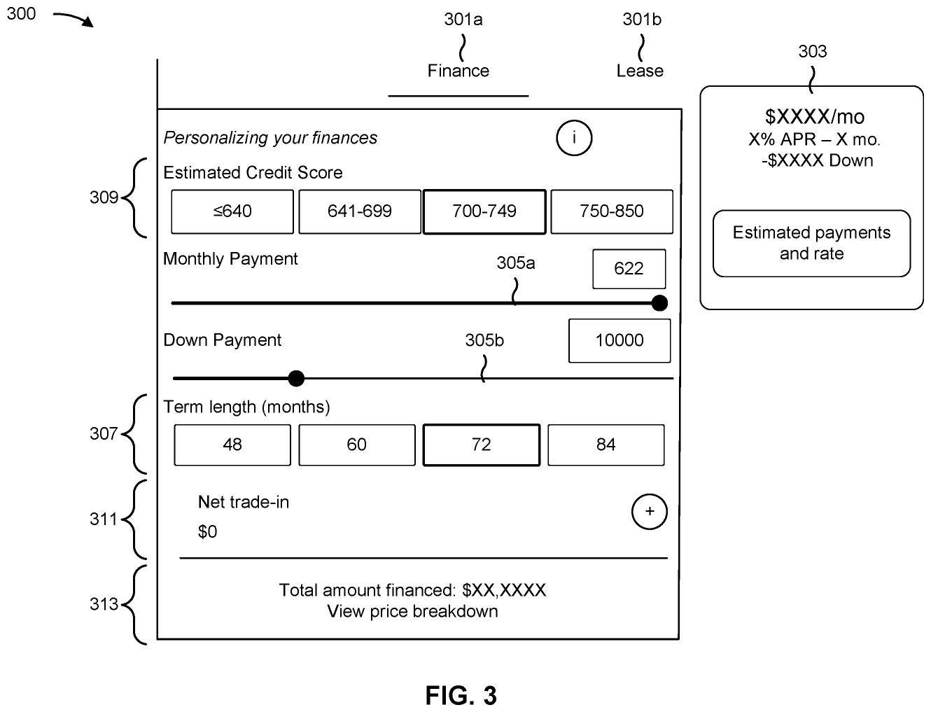

The webpage may encode a scaffold with a set of slots. The set of slots may include a plurality of slots. Each “slot” may define an area of pixels to be filled with a website element. For example, an “options” slot may define an area for sliders and/or buttons (as shown in FIG. 3) and an “addons” slot may define an area for text boxes (as further shown in FIG. 3). Additionally, the set of slots may be arranged relative to each other. For example, a “sidebar” slot may be next to a main slot (one or more main slots). Similarly, a “footer” slot may be a main slot that is below other main slots. Because the set of slots may be defined with short HTML and/or CSS code, the user device may receive and process the webpage quickly (due to low network overhead and low processing overhead).

As shown in FIG. 1B and by reference number 125a, the user device and the registry host may communicate to determine a set of feature flags. For example, the user device may transmit, and the registry host may receive, a request for feature flags. The request for feature flags may include an HTTP request and/or may be a call to an API function. The user device may include an identifier associated with the webpage (e.g., a domain name and/or an IP address, among other examples) in order to receive feature flags associated with the webpage. Additionally, or alternatively, the user device may include an identifier associated with the user device (e.g., a machine name, an IP address, and/or a medium address control (MAC) address, among other examples) in order to receive feature flags associated with the webpage.

Although the example 100 is described with the registry host being at least partially separate (e.g., logically, virtually, and/or physically) from the website host, other examples may include the registry host being integrated with the website host. Accordingly, the user device may transmit the request for feature flags to the website host (e.g., together with the request for the webpage or separately from the request for the webpage). Alternatively, a device at least partially separate (e.g., logically, virtually, and/or physically) from both the website host and the registry host may receive the request for feature flags and transmit the set of feature flags in response.

Furthermore, the registry host may transmit, and the user device may receive, the set of feature flags. The registry host may transmit the set of feature flags in response to the request for feature flags. The set of feature flags may be included in an HTTP response and/or may be returned based on a call to an API function (hosted by, or at least associated with, the registry host).

Additionally, or alternatively, as shown by reference number 125b, the user device may determine the set of feature flags. For example, the webpage may include code (e.g., in an HTML file and/or a JavaScript file) that the user device may execute to determine a set of bits (e.g., a set of Booleans) that comprise the set of feature flags.

As shown by reference number 130, the user device may transmit, and the registry host may receive, a request for website elements. The request for website elements may include an HTTP request and/or an FTP request, among other examples. The user device may transmit the request based on the set of feature flags. For example, the request may indicate the set of feature flags (e.g., as a bitmap or another type of data structure that encodes the set of feature flags). The request may include the set of feature flags in a header and/or a body of the request.

The request for website elements may be for a subset of website elements out of a set of possible website elements. As a result, the user device only requests code for website elements that will be output, which reduces network overhead, memory overhead, and processing overhead. The subset of website elements may include a plurality of website elements. The subset of website elements may be from a registry (e.g., stored and/or managed by the registry host). For example, the set of possible website elements may be encoded in a registry file (e.g., at least one registry file), such as a JavaScript file (or another type of file that defines website components). Accordingly, the registry host may retrieve code for the subset of website elements, from the registry file, based on the request. For example, the registry host may map the set of feature flags to the subset of website elements (e.g., using a table, a formula, or another type of data structure that maps feature flags to website elements).

Although the example 100 is described with the registry host processing the feature flags, other examples may include the user device processing the feature flags. For example, the webpage may include code (e.g., in an HTML file and/or a JavaScript file) that the user device may execute to identify the subset of website elements based on the set of feature flags. Accordingly, the request for website elements may indicate the subset of website elements (e.g., using names associated with the subset of websites) in addition to, or in lieu of, indicating the set of feature flags.

As shown by reference number 135, the registry host may transmit, and the user device may receive, code for the subset of website elements. The subset of website elements may correspond to the set of slots. For example, code for each website element may indicate a corresponding slot into which the website element may be output (or rendered). The registry host may transmit the code in response to the request for website elements.

As shown in FIG. 1C and by reference number 140, the user device may output the subset of website elements in the set of slots. For example, the user device may render the webpage and include the subset of website elements. The user device may output the webpage using an output component of the user device (e.g., into a tab of the web browser described above).

In some implementations, the code for the subset of website elements may define a plurality of placeholders. For example, a placeholder for a website element may define a set of pixels to reserve while the website element loads. The website element loading may depend on the user device processing code for the website element and/or the user device performing a lazy load of the website element (e.g., based on the website element being defined using a JavaScript import). As a result, the placeholder improves the user's experience (by displaying the set of pixels during a loading process). Additionally, the user device may output the subset of website elements to replace the plurality of placeholders. As a result, the placeholders conserve power and processing resources at the user device because the user device may refrain from re-arranging the webpage once the subset of website elements are loaded (which would happen if other parts of the webpage loaded and no placeholders were present for the subset of website elements).

The code for the subset of website elements may define shared properties. For example, a shared property for a website element may indicate a name of a variable on which the website element depends. For example, the variable may be a numerical value that is visually represented by the website element or that is input into a formula whose output is visually represented by the website element. Therefore, whenever the shared property changes, the website element may automatically update. As a result, power, processing resources, and memory overhead are conserved that otherwise would have been wasted in duplicating changes in a variable associated with one website element across other website elements.

The code for the subset of website elements may define subscribed events. For example, a subscribed event for a website element may indicate a name of an event that triggers a change to the website element. For example, the event may be associated with a different website element and/or input from the user. Therefore, whenever the subscribed event occurs, the website element may automatically update. Moreover, if the subscribed event for one website element is associated with a different website element that is unloaded (e.g., based on the set of feature flags), the user device may refrain from monitoring for the subscribed event. As a result, power, processing resources, and memory overhead are conserved that otherwise would have been wasted in initializing and maintaining separate event monitors for every website elements as well as initializing and maintaining event monitors for events that will not occur (e.g., because the events depend on unloaded website elements).

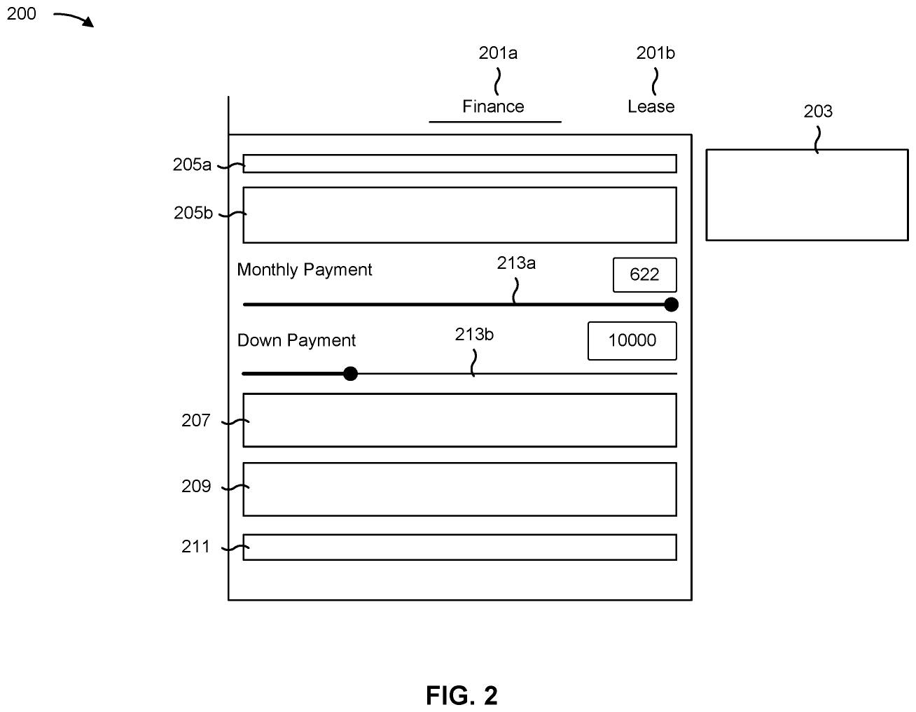

As shown by reference number 145, the user device may transmit, and the registry host may receive, a request for additional website elements. For example, the user of the user device may interact with a portion of the webpage (e.g., a tab, as described in connection with FIGS. 2 and 3) that triggers loading of an additional subset of website elements out of the set of possible website elements. Accordingly, the user device may request the additional subset of website elements from the registry host (e.g., similarly as described above for the subset of website elements).

As shown by reference number 150, the registry host may transmit, and the user device may receive, code for the additional subset of website elements (e.g., similarly as described above for the code for the subset of website elements). Because the user device only requests the additional subset of website elements when needed, the user device conserves memory overhead that otherwise would have been wasted on storing the code for the additional subset of website elements.

As shown in FIG. 1D and by reference number 155, the user device may move a website element (e.g., at least one website element), in the subset of website elements, from a first slot (in the set of slots) to a second slot (in the set of slots). For example, the user may provide input that triggers the user device to re-arrange the subset of website elements. Because slots are defined separately (in code) from website elements, the user device may move the website element without communicating with the registry host (or the website host) again. Accordingly, the user device may refrain from transmitting a request for the website element (that is being moved) and thus conserve power, processing resources, and network overhead. Additionally, the user device may have received a custom value (e.g., at least one custom value) for the website element. As shown in FIG. 3, the custom value may include a down payment, a monthly payment, a credit score, a trade-in value, or a term, among other examples. Because the user device is not re-loading the website element from scratch, the user device may move the website element and preserve the custom value.

Additionally, or alternatively, as shown by reference number 160, the user device may hide the subset of website elements based on a first interaction (e.g., based on the user selecting a tab associated with different elements, as described above and in connection with FIG. 3) and re-output the subset of website elements based on a second interaction (e.g., based on the user selecting a tab associated with the subset of website elements). The user device may cache code for the subset of website elements such that the user device may re-output the subset of website elements without communicating with the registry host (or the website host) again. Accordingly, the user device may refrain from re-transmitting a request for the subset of website elements and thus conserve power, processing resources, and network overhead. Additionally, the user device may have received a custom value (e.g., at least one custom value) for the subset of website elements. As shown in FIG. 3, the custom value may include a down payment, a monthly payment, a credit score, a trade-in value, or a term, among other examples. Because the user device is not re-loading the subset of website elements from scratch, the user device may re-output the subset of website elements and preserve the custom value.

By using techniques as described in connection with FIGS. 1A-1D, the user device may request the subset of website elements, out of the set of possible website elements, from the registry host. As a result, the user device receives and processes only a portion of code included in the registry file at the registry host, which conserves network overhead, processing resources, and memory as compared with receiving and processing code for the whole set of possible website elements. Additionally, the webpage loads faster, which improves a user's experience. Additionally, the user device may use the set of feature flags to determine the subset of website elements to request. As a result, the user device conserves processing resources as compared with using a computationally-heavy switch statement.

As indicated above, FIGS. 1A-1D are provided as an example. Other examples may differ from what is described with regard to FIGS. 1A-1D.

FIG. 2 is a diagram of an example UI 200 generated by systems and/or methods described herein. For example, the user device may output the example UI 200 based on instructions from the registry host. These devices are described in more detail in connection with FIGS. 4 and 5.

As shown in FIG. 2, a tab 201a is selected such that the user device requests code for website elements associated with the tab 201a and refrains from requesting code for website elements associated with a tab 201b. As a result, the user device conserves network overhead, processing resources, power, and memory overhead. Additionally, or alternatively, the user device requests code for website elements based on a set of feature flags, as described in connection with FIG. 1B.

As further shown in FIG. 2, the user device outputs a plurality of placeholders while requested website elements are loading. For example, a sidebar slot may be filled with placeholder 203 while a website element corresponding to the sidebar slot is loading. Similarly, a header slot may be filled with placeholders 205a and 205b while website elements corresponding to the header slot are loading. Furthermore, an options slot may be filled with a placeholder 207 while a website element corresponding to the options slot is loading, an addons slot may be filled with a placeholder 209 while a website element corresponding to the addons slot is loading, and a footer slot may be filled with a placeholder 211 while a website element corresponding to the footer slot is loading.

In some implementations, the user device may output some website elements that are loaded even while other website elements are still loading. For example, as shown in FIG. 2, sliders 213a and 213b are rendered in the options slot even though website elements corresponding to other slots are still loading (as well as a website element, corresponding to the options slot, that will replace the placeholder 207).

As indicated above, FIG. 2 is provided as an example. Other examples may differ from what is described with regard to FIG. 2. For example, different slots and/or fewer or additional slots may be included. Additionally, or alternatively, a slot shown in FIG. 2 may correspond to fewer or additional website elements (and thus include fewer or additional placeholders).

FIG. 3 is a diagram of an example UI 300 generated by systems and/or methods described herein. For example, the user device may output the example UI 300 based on instructions from the registry host. These devices are described in more detail in connection with FIGS. 4 and 5.

As shown in FIG. 3, a tab 301a is selected such that the user device outputs website elements associated with the tab 301a. As described in connection with FIG. 1D, website elements associated with a tab 301b may be hidden and may be re-output (e.g., based on a user of the user device interacting with the tab 301b) without re-transmitting a request for the website elements associated with the tab 301b. As a result, the user device improves the user's experience and conserves network overhead.

As further shown in FIG. 3, a website element 303 may fill a sidebar slot. In some implementations, website element 303 may share properties (e.g., as described in connection with FIG. 1C) with sliders 305a and 305b (e.g., a down payment property and a monthly payment property) such that the website element 303 automatically updates when the properties change (e.g., based on the user interacting with the slider 305a and/or the slider 305b). The sliders 305a and 305b may fill an options slot along with a set of buttons 307. In some implementations, the slider 305a may subscribe to an event (e.g., as described in connection with FIG. 1C) triggered by selection of a different button in the set of buttons 307. Accordingly, selection of a different button, in the set of buttons 307, may trigger the slider 305a to change values.

FIG. 3 also shows a set of buttons 309 that fill a header slot. In some implementations, the slider 305b may subscribe to an event (e.g., as described in connection with FIG. 1C) triggered by selection of a different button in the set of buttons 309. Accordingly, selection of a different button, in the set of buttons 309, may trigger the slider 305b to change values. Additionally, a text box 311 may fill an addons slot, and a text display 313 may fill a footer slot. The slider 305a and/or the slider 305b may subscribe to an event (e.g., as described in connection with FIG. 1C) triggered by entry of new input into the text box 311. Similarly, the text display 313 may also subscribe to the event triggered by entry of new input into the text box 311.

As indicated above, FIG. 3 is provided as an example. Other examples may differ from what is described with regard to FIG. 3. For example, different slots and/or fewer or additional slots may be included. Additionally, or alternatively, a slot shown in FIG. 3 may include fewer or additional website elements. Additionally, or alternatively, a website element shown in FIG. 3 may be associated with different shared properties and/or different subscribed events.

FIG. 4 is a diagram of an example environment 400 in which systems and/or methods described herein may be implemented. As shown in FIG. 4, environment 400 may include a registry host 401, which may include one or more elements of and/or may execute within a cloud computing system 402. The cloud computing system 402 may include one or more elements 403-412, as described in more detail below. As further shown in FIG. 4, environment 400 may include a network 420, a user device 430, a DNS resolver 440, and/or a website host 450. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the registry host 401 may include one or more elements 403-412 of the cloud computing system 402, may execute within the cloud computing system 402, and/or may be hosted within the cloud computing system 402, in some implementations, the registry host 401 may not be cloud-based (e.g., may be implemented outside of a cloud computing system) or may be partially cloud-based. For example, the registry host 401 may include one or more devices that are not part of the cloud computing system 402, such as device 500 of FIG. 5, which may include a standalone server or another type of computing device. The registry host 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 430 may include one or more devices capable of receiving, generating, storing, processing, and/or providing information associated with webpages, as described elsewhere herein. The user device 430 may include a communication device and/or a computing device. For example, the user device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 430 may communicate with one or more other devices of environment 400, as described elsewhere herein.

The DNS resolver 440 may include one or more devices capable of receiving, generating, storing, processing, providing, and/or routing information associated with domain names, as described elsewhere herein. The DNS resolver 440 may include a communication device and/or a computing device. For example, the DNS resolver 440 may include a server, such as an application server, a client server, a web server, a database server, a host server, a proxy server, a virtual server (e.g., executing on computing hardware), or a server in a cloud computing system. In some implementations, the DNS resolver 440 may include computing hardware used in a cloud computing environment. The DNS resolver 440 may communicate with one or more other devices of environment 400, as described elsewhere herein.

The website host 450 may include one or more devices capable of receiving, generating, storing, processing, and/or providing information associated with websites, as described elsewhere herein. The website host 450 may include a communication device and/or a computing device. For example, the website host 450 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The website host 450 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with reducing website overhead using registries. The device 500 may correspond to a user device 430, a DNS resolver 440, and/or a website host 450. In some implementations, a user device 430, a DNS resolver 440, and/or a website host 450 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

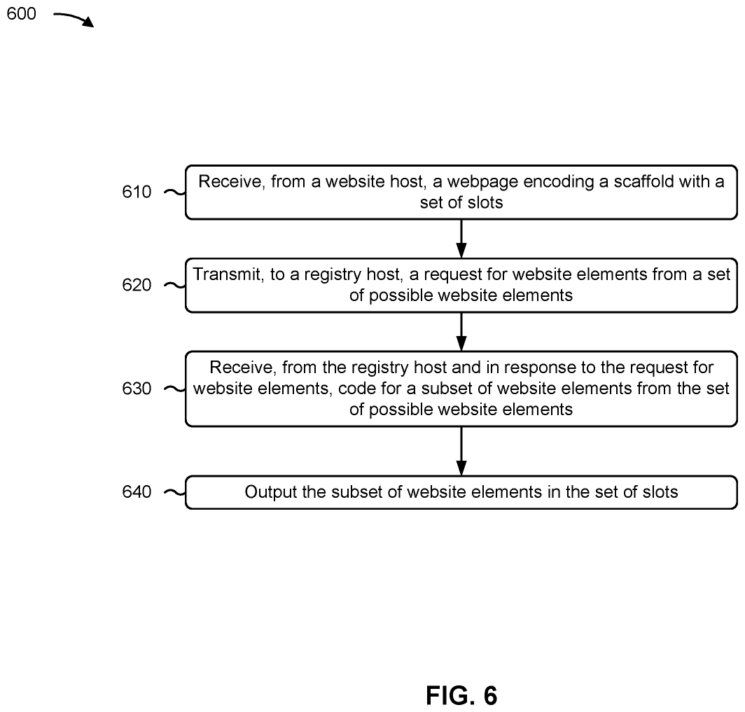

FIG. 6 is a flowchart of an example process 600 associated with reducing website overhead using registries. In some implementations, one or more process blocks of FIG. 6 may be performed by a user device 430. In some implementations, one or more process blocks of FIG. 6 may be performed by another device or a group of devices separate from or including the user device 430, such as a registry host 401, a DNS resolver 440, and/or a website host 450. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a website host, a webpage encoding a scaffold with a set of slots (block 610). For example, the user device 430 (e.g., using processor 520, memory 530, input component 540, and/or communication component 560) may receive, from a website host, a webpage encoding a scaffold with a set of slots, as described above in connection with reference number 120 of FIG. 1A. As an example, the user device 430 may transmit a request (e.g., an HTTP request) for the webpage, and the website host may transmit the webpage in response to the request. The webpage may at least one HTML file, at least one CSS file, and/or at least one JavaScript file, among other examples.

As further shown in FIG. 6, process 600 may include transmitting, to a registry host, a request for website elements from a set of possible website elements (block 620). For example, the user device 430 (e.g., using processor 520, memory 530, and/or communication component 560) may transmit, to a registry host, a request for website elements from a set of possible website elements, as described above in connection with reference number 130 of FIG. 1B. As an example, the request may include an HTTP request and/or an FTP request, among other examples, that indicates a set of feature flags (e.g., as a bitmap) associated with a subset of website elements from the set of possible website elements. In some implementations, the request may directly indicate the subset of website elements (e.g., as determined by the user device 430) in addition to, or in lieu of, indicating the set of feature flags.

As further shown in FIG. 6, process 600 may include receiving, from the registry host and in response to the request for website elements, code for a subset of website elements from the set of possible website elements (block 630). For example, the user device 430 (e.g., using processor 520, memory 530, input component 540, and/or communication component 560) may receive, from the registry host and in response to the request for website elements, code for a subset of website elements from the set of possible website elements, as described above in connection with reference number 135 of FIG. 1B. As an example, the code may indicate a corresponding slot, from the set of slots, into which each website element may be output (or rendered).

As further shown in FIG. 6, process 600 may include outputting the subset of website elements in the set of slots (block 640). For example, the user device 430 (e.g., using processor 520, memory 530, and/or output component 550) may output the subset of website elements in the set of slots, as described above in connection with reference number 140 of FIG. 1C. As an example, the user device 430 may render the webpage and include the subset of website elements. The user device 430 may output the webpage using an output component of the user device (e.g., into a tab of a web browser executed by the user device).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D, FIG. 2, and/or FIG. 3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using registries to selectively load website elements, the system comprising:
one or more memories; and
one or more processors, communicatively coupled to the one or more memories, configured to:
receive a webpage encoding a scaffold with a plurality of slots;
transmit a request for feature flags;
receive, in response to the request for feature flags, a set of feature flags;
transmit a request for website elements, from a registry, based on the set of feature flags;
receive, in response to the request for website elements, code for a plurality of website elements corresponding to the plurality of slots; and
output the plurality of website elements in the plurality of slots.

2. The system of claim 1, wherein the one or more processors are configured to:
output a plurality of placeholders, corresponding to the plurality of slots,
wherein the plurality of website elements are output to replace the plurality of placeholders.

3. The system of claim 1, wherein the one or more processors are configured to:
transmit a query to a domain name system (DNS) resolver;
receive a response to the query from the DNS resolver; and
transmit a request for the webpage based on the response to the query,
wherein the webpage is received in response to the request for the webpage.

4. The system of claim 1, wherein the one or more processors are configured to:
move at least one website element, in the plurality of website elements, from a first slot in the plurality of slots to a second slot in the plurality of slots; and
refrain from transmitting a request for the at least one website element.

5. The system of claim 4, wherein the one or more processors are configured to:
receive a custom value associated with the at least one website element,
wherein the custom value is preserved after the at least one website element is moved.

6. The system of claim 1, wherein the one or more processors are configured to:
hide the plurality of website elements based on a first interaction;
re-output the plurality of website elements based on a second interaction; and
refrain from re-transmitting a request for website elements.

7. The system of claim 6, wherein the one or more processors are configured to:
receive at least one custom value associated with the plurality of website elements,
wherein the at least one custom value is preserved after the plurality of website elements are re-output.

8. A method of using registries to selectively load website elements, comprising:
receiving, from a website host, a webpage encoding a scaffold with a set of slots;
transmitting, to a registry host, a request for website elements from a set of possible website elements;
receiving, from the registry host and in response to the request for website elements, code for a subset of website elements from the set of possible website elements; and
outputting, by a user device, the subset of website elements in the set of slots.

9. The method of claim 8, further comprising:
outputting, by the user device, a set of placeholders, corresponding to the set of slots,
wherein the subset of website elements are output to replace the set of placeholders.

10. The method of claim 8, wherein the webpage encoding the scaffold comprises at least one hypertext markup language file.

11. The method of claim 8, wherein transmitting the request for website elements comprises:
transmitting the request including a set of feature flags associated with the user device.

12. The method of claim 8, further comprising:
determining, by the user device, the subset of website elements,
wherein the request for website elements indicates the subset of website elements.

13. The method of claim 8, wherein outputting the subset of website elements comprises:
rendering the webpage including the subset of website elements.

14. A non-transitory computer-readable medium storing a set of instructions for using registries to selectively load website elements, the set of instructions comprising:
one or more instructions that, when executed by one or more processors of a device, cause the device to:
receive a request for website elements from a set of possible website elements;
retrieve, from at least one registry file, code for a subset of website elements from the set of possible website elements; and
transmit, in response to the request for website elements, the code for the subset of website elements.

15. The non-transitory computer-readable medium of claim 14, wherein the at least one registry file comprises at least one JavaScript file.

16. The non-transitory computer-readable medium of claim 14, wherein the one or more instructions, when executed by the one or more processors, cause the device to:
receive a request for feature flags; and
transmit, in response to the request for feature flags, a set of feature flags.

17. The non-transitory computer-readable medium of claim 14, wherein the one or more instructions, when executed by the one or more processors, cause the device to:
map a set of feature flags, included in the request for website elements, to the subset of website elements.

18. The non-transitory computer-readable medium of claim 14, wherein the one or more instructions, when executed by the one or more processors, cause the device to:
determine the subset of website elements based on an indication in the request for website elements.

19. The non-transitory computer-readable medium of claim 14, wherein the request for website elements comprises an application programming interface call.

20. The non-transitory computer-readable medium of claim 14, wherein the request for website elements comprises a hypertext transfer protocol request.
